(19) United States
(12) Patent Application Publication
(10) Pub. No.: US 2025/0332669 A1
(43) Pub. Date: Oct. 30, 2025

(54) Rod pulling device.

(71) Applicant: ECHAFAUDAGES SECUR-IT INC., Sherbrooke (CA)

(72) Inventors: Germain Depot, St-Denis de Brompton (CA); Stéphane Bernard, Stoke (CA)

(21) Appl. No.: 19/261,006

(22) Filed: Jul. 7, 2025

Related U.S. Application Data
(63) Continuation-in-part of application No. 17/937,174, filed on Sep. 30, 2022.
(60) Provisional application No. 63/251,368, filed on Oct. 1, 2021.

(51) Int. Cl. B23P 19/02

(52) U.S. Cl. CPC B23P 19/022

(57) ABSTRACT

A rod pulling device for pulling a rod anchored in surrounding material, the rod pulling device comprising: a substantially elongated device body; a carriage movable along the device body; an actuator operatively coupled to the carriage for selectively moving the carriage along the device body; and a gripping assembly mounted to the carriage for selectively gripping the rod; wherein the gripping assembly includes a pair of jaws each defining a respective gripping surface for gripping the rod, the gripping surfaces facing each other and defining a gap therebetween for receiving the rod, the jaws being movable between open and closed configurations, the gap being narrower in the closed configuration than in the open configuration; and a clutch operative for decoupling the carriage from the actuator so that the carriage is prevented from moving further than a predetermined location along the device body while the actuator remains activated.

### FIELD OF THE INVENTION

The present invention relates to the general field of tools, and is more specifically concerned with a rod pulling device, for example to pull from the ground stakes used in temporary structures, such as in concrete forms.

### BACKGROUND

There are many instances in which an elongated rod is firmly anchored in surrounding material. For example, such rods my be used to anchor or otherwise stabilize a structure. In a specific example, concrete forms may be braced by inserting metal stakes into the ground adjacent the form. Once the concrete has set into the form, these stakes must be removed so that the form can be disassembled. Due to the need for the stakes to provide a robust reinforcement, the stakes are relatively difficult to remove as they are stably anchored. Removal typically performed manually, using muscle power and hand tools to hit on the stakes to loosen them up enough that they can then be pulled. This process is time consuming, arduous, and presents injury risks to the involved workers.

Against this background, there exists a need in the industry for novel methods and devices to remove anchored rods such as concrete form stakes. An object of the present invention is to provide such methods and devices.

### SUMMARY OF THE INVENTION

In a broad aspect, there is provided a rod pulling device for pulling a rod anchored in surrounding material, the rod pulling device comprising: a substantially elongated device body; a carriage movable along the device body; an actuator operatively coupled to the carriage for selectively moving the carriage along the device body; and a gripping assembly mounted to the carriage for selectively gripping the rod. The gripping assembly includes a pair of jaws each defining a respective gripping surface for gripping the rod, the gripping surfaces facing each other and defining a gap therebetween for receiving the rod, the jaws being movable between open and closed configurations, wherein the gap is narrower in the closed configuration than in the open configuration.

There may also be provided a rod pulling device wherein the carriage includes a carriage body mounted to the device body so as to be longitudinally movable therealong while being prevented from rotating thereabout, the carriage body defining a threaded aperture extending longitudinally therethrough; the actuator includes a shaft extending longitudinally along the device body, the shaft being fixed in translation and axially rotatable relative to the device body, the shaft including a threaded driving section for engaging the threaded aperture. Rotating the shaft relative to the device body with the threaded aperture engaged in the driving section moves the carriage along the device body.

There may also be provided a rod pulling device wherein the carriage body is received in a track defined by the device body.

There may also be provided a rod pulling device wherein the carriage includes rollers mounted to the carriage body and rotatable relative thereto, the rollers being positioned for engaging the device body at least intermittently when the carriage is moved along the track so as to roll therealong.

There may also be provided a rod pulling device wherein the device body defines a foot for abutting against the surrounding material when the rod is pulled by the gripping assembly; and the shaft is provided with a disengagement section terminating the driving section spaced apart from the foot; wherein the disengagement section is configured to be disengaged from the threaded aperture when the threaded aperture is in register therewith so that the carriage remains fixed relative to the device body when the threaded aperture reaches the threaded aperture when the shaft is rotated.

There may also be provided a rod pulling device wherein the disengagement section is recessed radially relative to the driving section.

There may also be provided a rod pulling device further comprising a biasing element provided adjacent the disengagement section and biasing the carriage towards the driving section when the threaded aperture is in register with the disengagement section.

There may also be provided a rod pulling device wherein: the carriage includes a carriage body mounted to the device body so as to be longitudinally movable therealong; the jaws each define opposed jaw first and second ends, the gripping surface being provided at the jaw first end; the gripping assembly further includes a link extending between the jaws, the jaws being each pivotally mounted to the link through a respective jaw-to-link pivot adjacent the jaw first ends; a pair of arms pivotally mounted to the carriage body, the jaws being pivotally mounted to a respective one of the arms closer to the jaw second end than the jaw-to-link pivot, the jaws being mounted to the arms opposed to the carriage body; wherein a distance between the gripping surface and the link-to-jaw pivot varies along the gripping surface so that moving the link longitudinally relative to the carriage body rotates the jaws relative to the link about the link-to-jaw pivots to result in variations of a width of the gap.

There may also be provided a rod pulling device wherein the arms are pivotally mounted to the body so as to be pivotable about respective arm pivot axes laterally spaced apart from each other.

There may also be provided a rod pulling device wherein the link and the arms are coplanar, the link being movable to a link proximalmost position relative to the arm pivot axes in which the link and the arms abut against each other, thereby preventing further movements of the link towards the arm pivot axes.

There may also be provided a rod pulling device wherein the jaws are in the open position when the link is in the link proximalmost position.

There may also be provided a rod pulling device wherein the link provides at least two jaw mount pairs each usable for mounting the jaws thereto, the at least two jaw mount pairs each including two jaw mounts, the two jaw mounts being distanced by a jaw mount distance, the jaw mount distances being different for the at least two jaw mount pairs.

There may also be provided a rod pulling device wherein the gripping surface includes an arcuate section eccentric relative to the link-to-jaw pivot and a rectilinear section extending from the arcuate section, the gripping surface getting further away from the link pivot along the rectilinear section in a direction leading away from the arcuate section.

There may also be provided a rod pulling device wherein the actuator includes a power coupler for coupling the shaft to a power source so that the power source is usable to rotate the shaft.

There may also be provided a rod pulling device wherein the power source is a drill, the power coupler including a socket for receiving a socket adapter mounted to the drill.

There may also be provided a rod pulling device further comprising a mounting bracket mounted to the body adjacent the power coupler for mounting the power source thereto.

There may also be provided a rod pulling device further comprising a handle protruding laterally from the device body.

There may also be provided a rod pulling device wherein the gripping surfaces are serrated.

In another broad aspect, there is provided a rod pulling device for pulling a rod anchored in surrounding material, the rod pulling device comprising: a substantially elongated device body; a carriage movable along the device body; an actuator operatively coupled to the carriage for selectively moving the carriage along the device body; and a gripping assembly mounted to the carriage for selectively gripping the rod; the gripping assembly including a pair of jaws each defining a respective gripping surface for gripping the rod, the gripping surfaces facing each other and defining a gap therebetween for receiving the rod, the jaws being movable between open and closed configurations, wherein the gap is narrower in the closed configuration than in the open configuration; the rod pulling device further comprising a clutch operative for decoupling the carriage from the actuator so that the carriage is prevented from moving further than a predetermined location along the device body while the actuator remains activated.

There may also be provided a rod pulling device wherein the device body defines opposed body proximal and distal ends, the clutch being provided at the body proximal end.

There may also be provided a rod pulling device wherein the device body defines opposed body proximal and distal ends, the clutch being provided at the body distal end.

There may also be provided a rod pulling device wherein the device body defines opposed body proximal and distal ends, the clutch being a distal clutch and provided at the body distal end, the rod pulling device further comprising a proximal clutch provided at the body proximal end operative for decoupling the carriage from the actuator so that the carriage is prevented from moving further than an other predetermined location along the device body while the actuator remains activated.

There may also be provided a rod pulling device wherein the clutch includes a disengagement section defined by the shaft adjacent the driving section, the carriage body being movable along the shaft so that the disengagement section is reachable by the threaded aperture; wherein the disengagement section is configured to be disengaged from the threaded aperture when the threaded aperture is in register therewith so that the carriage remains fixed relative to the device body when the threaded aperture reaches the threaded aperture when the shaft is rotated.

Advantageously, the rod pulling device may use power from a motor, such as the motor of a hand drill, to pull the rods, which alleviates many of the disadvantages of manual rod removal. The rod pulling device is also relatively ergonomic to use. In some embodiments, the same device may be used with stakes or rods of different diameters.

The present application claims benefit from provisional patent application 63/251,368 filed Oct. 1, 2021 and U.S. patent application Ser. No. 17/937,174 filed Sep. 30, 2022, the contents of which is hereby incorporated by reference in its entirety.

Other objects, advantages and features of the present invention will become more apparent upon reading of the following non-restrictive description of some embodiments thereof, given by way of example only with reference to the accompanying drawings.

### BRIEF DESCRIPTION OF THE DRAWINGS

FIG. 1, in a perspective view, illustrates a rod pulling device in accordance with an embodiment of the present invention.

FIG. 2, in a front elevation view, illustrates the rod pulling device of FIG. 1;

FIG. 3, in a perspective exploded view, illustrates the rod pulling device of FIG. 1;

FIGS. 4A, in a front elevation view, illustrates a step in the use of the rod pulling device of FIGS. 1 to 3;

FIGS. 4B, in a front elevation view, illustrates another step in the use of the rod pulling device of FIGS. 1 to 3;

FIGS. 4C, in a front elevation view, illustrates yet another step in the use of the rod pulling device of FIGS. 1 to 3;

FIG. 5, in a perspective view, illustrates a rod pulling device in accordance with another embodiment of the present invention;

FIG. 6, in a front elevation view, illustrates the rod pulling device of FIG. 5;

FIG. 7, in a perspective exploded view, illustrates the rod pulling device of FIG. 5;

FIG. 8, in a front elevation view, illustrates part of the rod pulling device of FIG. 5;

FIG. 9, in a side cross-sectional view along section line IX-IX of FIG. 8, illustrates part of the rod pulling device of FIG. 5 with a carriage thereof at a first position along a shaft thereof; and

FIG. 10, in a side cross-sectional view along a section line similar to section line IX-IX of FIG. 8, illustrates the carriage at a second position along the shaft.

### DETAILED DESCRIPTION

The term “substantially” is used throughout this document to indicate variations in the thus qualified terms. These variations are variations that do not materially affect the manner in which the invention works and can be due, for example, to uncertainty in manufacturing processes or to small deviations from a nominal value or ideal shape that do not cause significant changes to the invention. These variations are to be interpreted from the point of view of the person skilled in the art.

Directional terminology, such as top and bottom, among others, refers to the orientation relative to an upstanding rod pulling device 100 pulling on a vertical rod 102. This terminology is used for clarity reasons and should not be used to restrict the scope of the claims unless explicitly claimed.

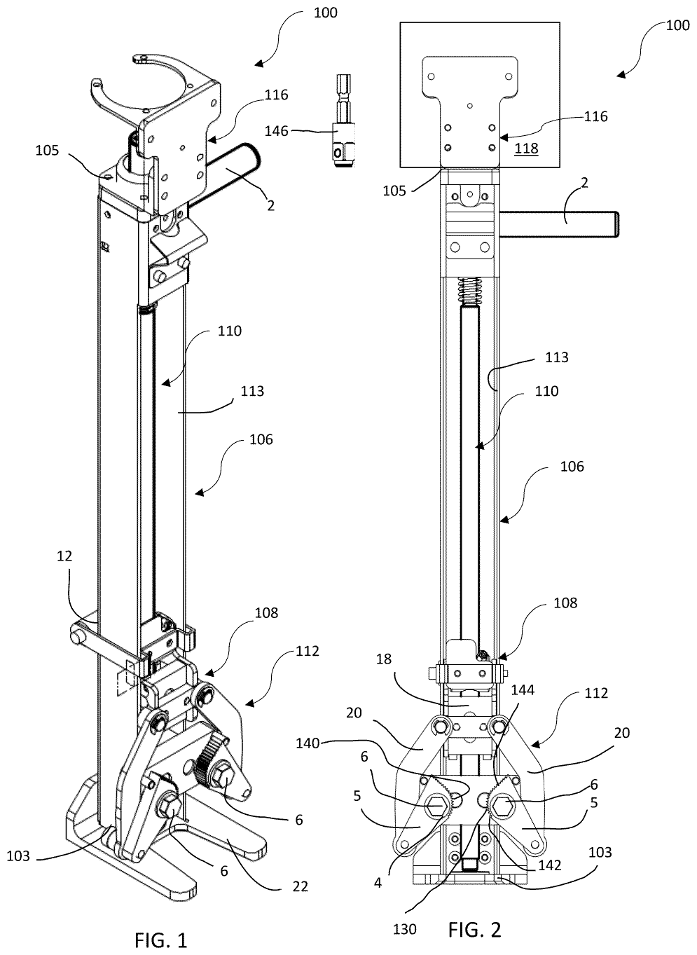

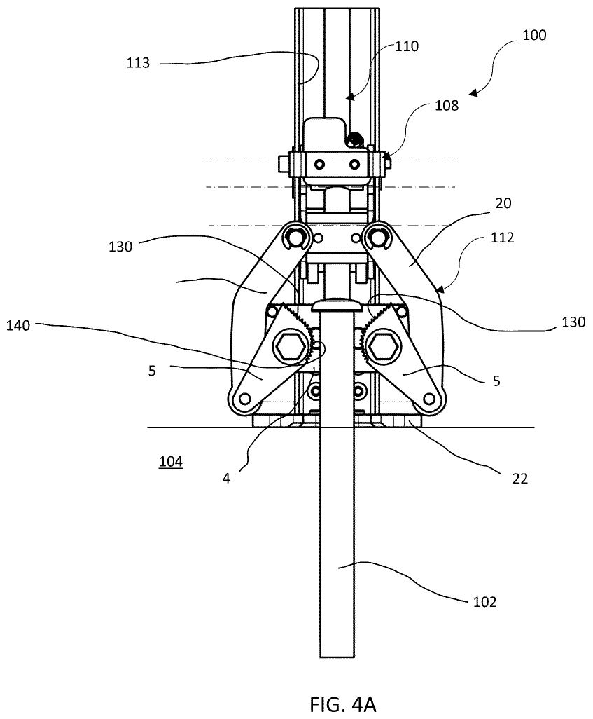

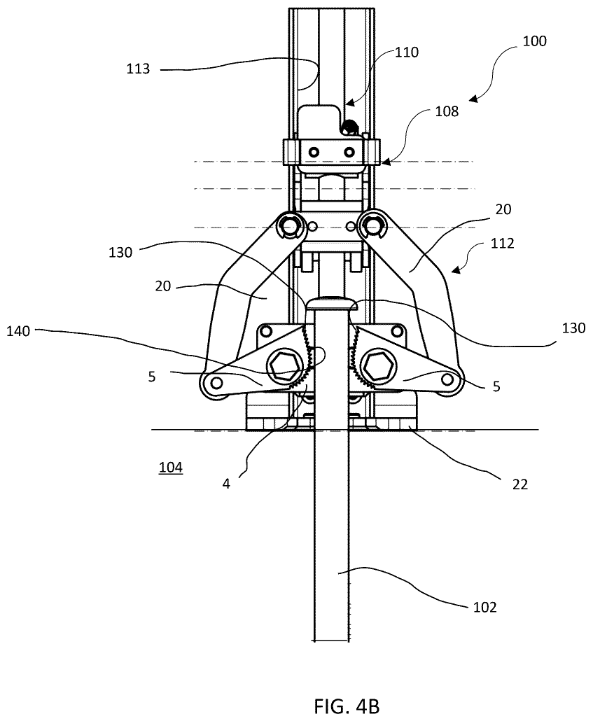

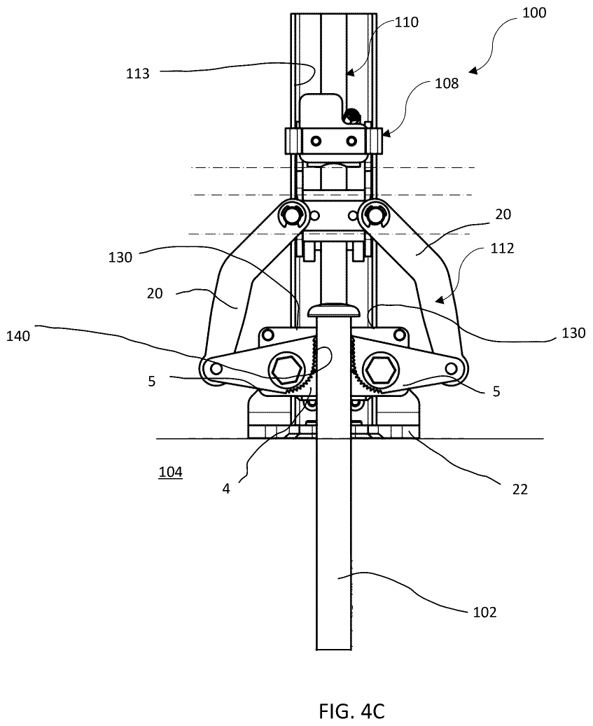

Referring collectively to FIGS. 1 and 2, there is shown an embodiment of a rod pulling device 100 for pulling a rod 102 (shown for example in FIGS. 4A to 4C in the form of a concrete form stake) anchored in surrounding material 104 (such as the ground as shown in FIGS. 4A to 4C). The rod pulling device 100 includes a substantially elongated device body 106, a carriage 108, an actuator 110 and a gripping assembly 112.

The device body 106 is typically fixed relative to the surrounding material 104, for example by abutting against an exposed surface thereof, when the anchored rod 102 is pulled. The device body 106 defines longitudinally opposed body distal and proximal ends 103 and 105. The body distal end 103 is the portion of the device body 106 that is closest to the surrounding material 104 when the device 100 is used to pull on the rod 102. The device body 106 defines a guide along which the carriage 108 is longitudinally movable. The guide takes for example the form of a track 113 extending longitudinally along the device body 106 in which at least part of the carriage 108 is mounted so as to be movable along the track 113 while being maintained thereinto.

In some embodiments, the device body 106 is provided with a foot 22 protruding laterally therefrom at the body distal end 103. The foot 22 may define a recess 114 for receiving the anchored rod 102 thereinto. The foot 22 may stabilize the rod pulling device 100 when the latter in use by abutting against the surrounding material 104 in which the anchored rod 102 is anchored. Also, in some embodiments, the foot 22 may be used to assist in moving the gripping assembly 112 to an open configuration, as further described below. In alternative embodiments, the foot 22 is simply formed by any other suitable structure at the body distal end 103, and need not protrude from the device body 106.

In some embodiments, the device body 106 is also provided with a mounting bracket 116, for example at the body proximal end 105, usable for mounting a power source 118 (illustrates schematically in FIG. 2) for the actuator 110. For example, the power source 118 takes the form of a battery powered drill configured to engage the actuator 110 to power the latter. However, any other suitable power source 118 usable to power the actuator 110 is usable, such as a dedicated motor and battery combination. The power source 118 may be secured to the mounting bracket 116, or the power source 118 may be simply stabilized by the mounting bracket 116, in which case the power source 118 may need additional support from an intended user of the rod pulling device 100.

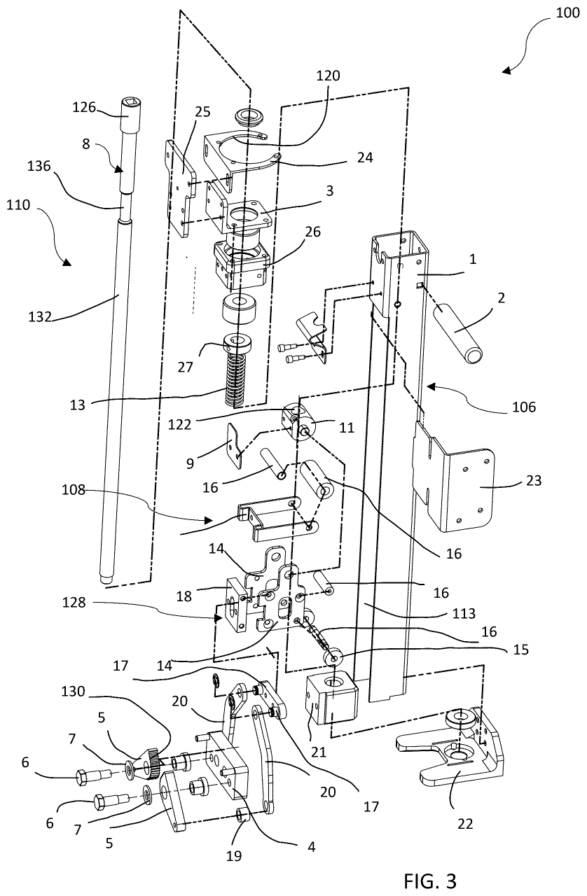

Referring to FIG. 3, the mounting bracket 116 may include a spacing plate 25 mounted to the device body 106 through a mounting bracket anchoring angle iron 3. The spacing plate 25 protrudes longitudinally from the device body 106 opposed to the foot 22. A substantially U-shaped member 24 is mounted to the spacing plate 25 perpendicularly thereto and defined a power source receiving recess 120 for receiving a suitably shaped portion of the power source 118. IN other embodiments, the mounting bracket 116 has any suitable shape that may assist in mounting the power source 118 to the remainder of the rod pulling device 100.

In some embodiments, the device body 106 is also provided with a handle 2, for example of cylindrical configuration, protruding laterally outwardly from the device body 106 adjacent the body proximal end 105. The handle 2 is usable to position and stabilize the rod pulling device 100.

The actuator 110 is operatively coupled to the carriage 108 for selectively moving the carriage 108 along the device body 106. The actuator 110 may take the form of a shaft 8 extending longitudinally along the device body 106 and fixedly mounted relative thereto. The shaft 8 includes a threaded driving section 132 for engaging a threaded aperture 122 provided in the carriage 108, as detailed below. The carriage 108 is fixed in rotation relative to the device body 106, so that when the shaft 8 is rotated with the threaded aperture 122 engaging the driving section 132, the carriage 108 is moved longitudinally along the device body 106. The actuator 110 also includes a power source coupler 126 for coupling the power source 118 thereto. For example, and non-limitingly, the power source coupler 126 takes the form of a socket welded to the shaft 8 so that a power drill may engage the socket in a conventional manner to rotate the shaft 8 using a conventional socket adapter 146 (seen in FIG. 1). Suitable bearings may be provided to support the shaft 8 in the track 113 so that the shaft 8 may rotate relatively easily while being maintained fixed in translation relative to the device body 106.

In some embodiments, the shaft 8 is provided with a disengagement section 136 terminating the driving section 132 spaced apart from the foot 22. The carriage 208 is configured so that the threaded aperture can be moved therealong and reach the disengagement section 136. The disengagement section 136 is configured to be disengaged from the threaded aperture 122 when the threaded aperture 122 is in register therewith so that the carriage 108 remains fixed relative to the device body 106 when the threaded aperture 122 reaches the disengagement section 136 when the shaft 8 is rotated. This configuration prevents the carriage 108 from transmitting large forces to the remainder of the rod pulling device 100 or to the power source 118 when reaching the end of its course closest to the power source 118. For example, the disengagement section 136 is defined by a portion of the shaft 8 that is recessed radially relative to the driving section 132. The disengagement section 136 forms a clutch operative for decoupling the carriage 108 from the actuator 110 so that the carriage 108 is prevented from moving further than a predetermined location, in this case beyond the disengagement section 136, along the device body 106 while the actuator 110 remains activated.

In some embodiments, a biasing element 13 is provided adjacent the disengagement section 136 and for biasing the carriage 108 towards the driving section 132 when the threaded aperture 122 is in register with the disengagement section 136. This facilitates engagement of the threaded aperture 122 and driving section 132 with each other when one wants to move the carriage 108 away from the disengagement section 136. For example, the biasing element 13 takes the form of a coil spring engaged on the shaft 8.

The carriage 108 includes a carriage body 128 to which rollers 12 and 15 are mounted. The rollers 12 and 15 are substantially parallel to each other and rotate about a rotation axis that is perpendicular to the shaft 8. A first one of the rollers 12 is provided outside of the device body 106, opposed to the track 113, and abuts against the device body 106 at least intermittently in use. The other two rollers 15 are provided inside the track 113 and abut an end wall thereof at least intermittently in use, so that part of the device body 106 is between the roller 12 and the rollers 15. Therefore, the rollers 12 and 15 limit movements of the carriage 108 so that the latter is maintained in the track 113 while allowing the carriage 108 to move along the track 113. The carriage body 128 is shaped complementarily to the track 113, so that the carriage body 128 is unable to rotate significantly in the track 113. The carriage body 128 is also shaped to only be movable longitudinally along the track 113. For example, the track 113 has a substantially U-shaped transversal cross-sectional configuration.

The carriage body 128 includes for example a pair of plates 14 positioned inside the track 113 opposite to each other and supporting the rollers 15 through a spindle 16 extending between the plates 14. In some embodiments, one or more additional spindle 16 is also provide between the plates 14. A gripper mount 18 extends between the plates 14 adjacent the opening of the track 113, for example supported slightly outside of the track 113. A roller support 10 is secured to the gripper mount 18 and supports the roller 12 through yet another spindle 16. To that effect, the roller support 13 is substantially U-shaped and extends around the device body 106, typically relatively snugly, so that the roller support 10 and roller 12 form a closed loop.

The carriage 108 also includes an actuator coupler 11 defining the threaded aperture 122 and fixedly mounted between the plates 14. Thus, the carriage 108 can only move significantly longitudinally, all other movements and rotations being substantially prevented by mechanical interference between the carriage 108 and the device body 106. Movements of the carriage 108 along the track 113 require rotation of the shaft 8.

The gripping assembly 112 includes a pair of arms 20, a pair of jaws 5 and a link 4. The gripping assembly 112 is mounted to the carriage 108 and movable between an open configuration, seen in FIG. 4A, and a closed configuration, seen in FIG. 4C. The jaws 5 each defined a gripping surface 130 for gripping the rod 102. As seen in FIG. 2, the gripping surfaces 130 face each other and define a gap 140 therebetween for receiving the rod 102. The gripping surfaces 130 are closer to each other in the closed configuration than in the open configuration, so that the gap 140 is narrower in the closed configuration than in the open configuration. In some embodiments, the gripping surfaces 130 are serrated to better bite into the anchored rods 102.

The arms 20 are substantially elongated and pivotally mounted to the gripper mount 18 at one one end thereof. The arms 20 may for example freely pivot about a common arm pivot (not shown in the drawings), which is perpendicular to the device body 106, or around two parallel arm pivots 17 laterally spaced apart from each other. Opposite arm pivots 17, the jaws 5 are pivotally mounted to the arms 20 opposite their gripping surfaces 130. The link 4 extends between the jaws 5 and is pivotally mounted to each of the jaws 5 adjacent the gripping surfaces 130 at a respective link pivot 6. Therefore, the gripper mount 18, arms 20, jaws 5 and link 4 form a closed loop of variable geometry. The link 4 may be provided with more than one mounting location for each jaw 5 so that the distance between of the jaws 5 can be varied to use the rod pulling device 100 with anchored rods 102 of different diameters.

In some embodiments, the link 4 is mounted coplanar with the arms 20, so that mechanical interference limits the movement of the jaws 5. Indeed, when the jaws 5 are pivoted to the open configuration, the link 4 is at a proximalmost position relative to the arm pivots 17 and located between the arms 20. In this position, the link 4 abuts against the arms 20, preventing further movements of the link 4 towards the arm pivots 17, as such movement would require an angle between the arms 20 to get smaller, which is prevented by the link 4. When the jaws 5 are pivoted to the closed configuration, the link 4 moves away from the arm pivots 17. In some embodiment, the link 4 may also further move past the closed configuration to reach a distalmost position in which the link 4 also abuts against the arms 20.

A distance between the gripping surface 130 and the link pivots 6 varies along the gripping surface 130, so that moving the link longitudinally relative to the carriage body rotates the jaws 5 relative to the link 4 about the link pivots 6 to result in variations of a width of the gap 140. The gripping surface 130 get further from the link pivot 6 in a direction leading towards the arm pivots 17 when the jaws 5 are in the open configuration. For example, the gripping surface 130 includes an arcuate section 142 eccentric relative to the link pivot 6 and a rectilinear section 144 extending from the arcuate section 142. Non-limtingly, the arcuate section 142 spans from about 80 to about 100 degrees, for example about 90 degrees. A distance between the gripping surface 130 and the link pivot 6 increases from the origin of the arcuate section 142 towards its intersection with the rectilinear section 144, and along the rectilinear section. Thus, pivoting the jaws 5 from a position in which the arcuate sections 142 face each other towards a position in which the rectilinear sections 144 face each other reduces the width of the gap 140. In some embodiments, the rectilinear sections 144 are close to parallel in the closed position, for example converging towards each other at an angle of between 1 and 10 degrees in a direction leading towards the body proximal end 105, when the rod 102 is gripped.

The gripping surfaces 130 are curved and configured such that a distance between each gripping surface 130 and its closest link pivot 6 varies along the gripping surface 130, so that when the link 4 is lowered from its proximalmost position, the gap 140 between the gripping surfaces 130 gets smaller. When the jaws 5 are in the open configuration, portions of the gripping surfaces 130 located relatively close to the link pivots 6 face each other. When the jaw 5 are in the closed configuration, portions of the gripping surfaces 130 located relatively far to the link pivots 6 face each other. Since the link pivots 6 are fixed relative to each other, this leads to variations in a width of the gap 140 between the gripping surfaces 130.

In use, to remove the anchored rod 102 from surrounding material 104, one lowers the carriage 108 as much as possible using the actuator 110. During this process, mechanical interference with either the foot 22 or the device body 106 stops the link 4 and/or jaws 5 from going down further than a predetermined location while the gripper mount 18 still goes down, which moves the jaws 5 to the open configuration. One can then position the rod pulling device 100 adjacent the anchored rod 102, as seen in FIG. 4A and insert a protruding portion of the anchored rod 102, outside of the surrounding material 104, between the gripping surfaces 130. In this configuration, the link 4 is closest to the arm pivots 17

Afterwards, one used the actuator 110 to move the carriage 108 upwardly, which allows the jaws 5 to move towards the closed position, as seen in succession in FIGS. 4B and 4C. Once the gripping surfaces 130 firmly grip the anchored rod 102, further movements of the carriage 108 will pull the anchored rod 102 from surrounding material 104 as the jaws 5 cannot close any further and they will be lifted by the upwardly moving carriage 108. Once the anchored rod 102 has been pulled enough, moving the carriage 108 slightly downward will release the anchored rod 102 from the jaws 5. This allows removal of the anchored rod 102 from the jaws 5.

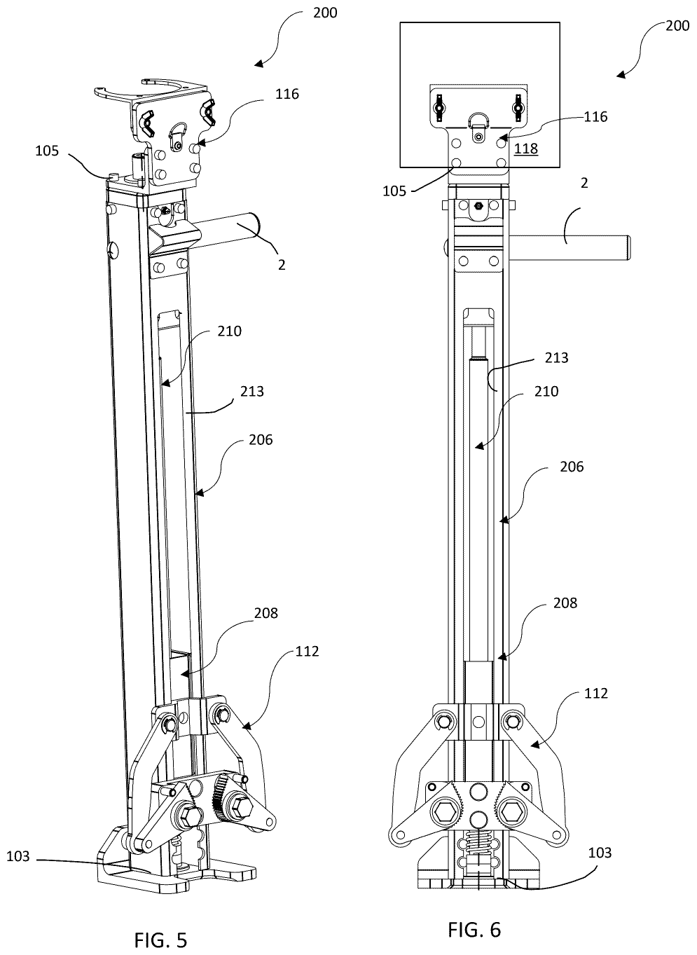

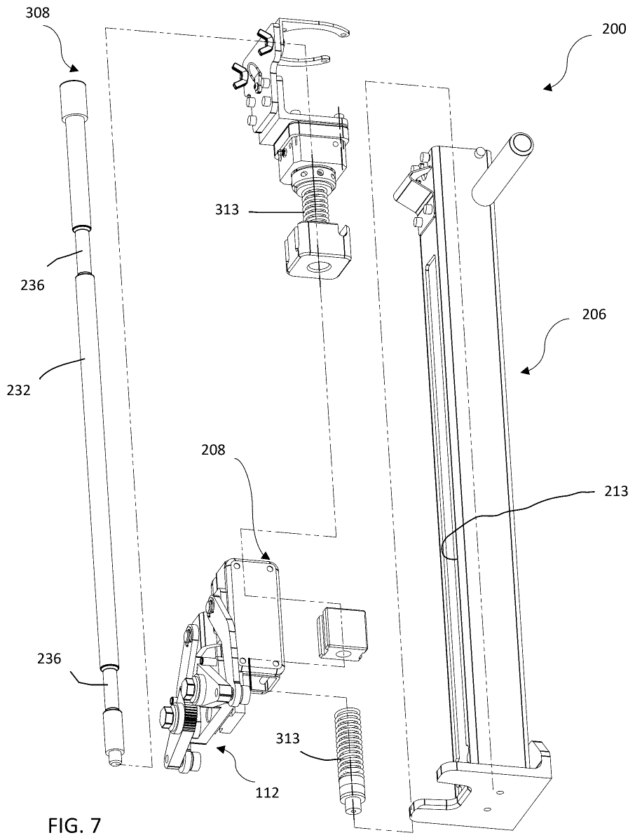

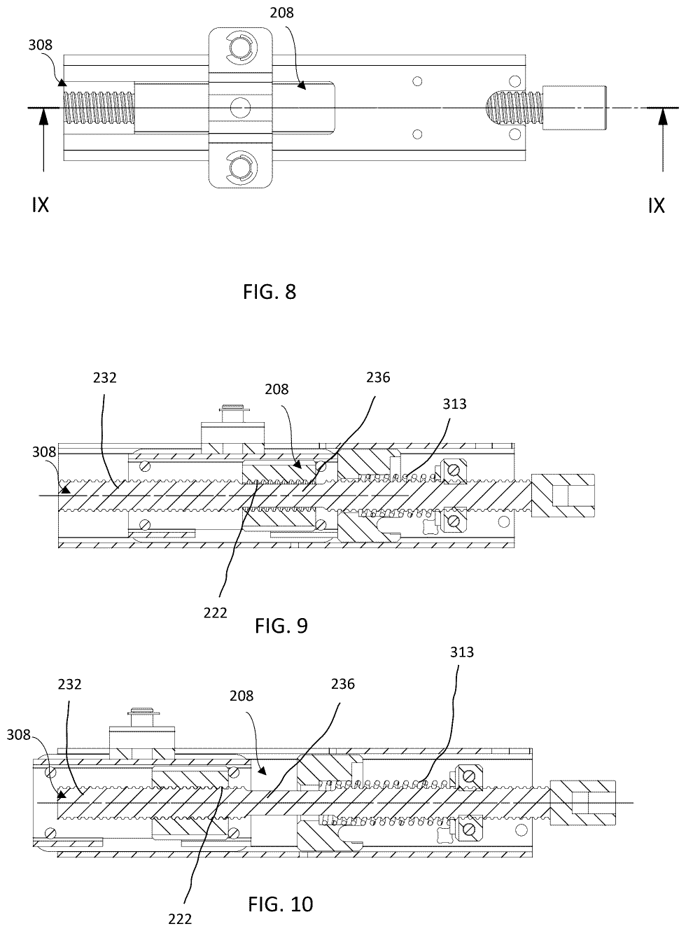

Referring collectively to FIGS. 5 to 10, there is shown another embodiment of a rod pulling device 200 for pulling a rod 102 (shown for example in FIGS. 4A to 4C in the form of a concrete form stake) anchored in surrounding material 104 (such as the ground as shown in FIGS. 4A to 4C). The rod pulling device 200 is similar to the rod pulling device 100, and only the differences therebetween are described in details.

A first difference between the rod pulling devices 100 and 200 resides in that the rod pulling devices 200 includes two clutches, a proximal one at the top and a distal one at the bottom. To that effect, the shaft 308 of the rod pulling device 200 defines two opposed disengagement sections 236 terminating the driving section 232 at both ends thereof. As in the rod pulling device 100, the actuator 210 is operatively coupled to the carriage 208 for selectively moving the carriage 208 along the device body 206 through the threaded driving section 232 that engaged a threaded aperture 222 provided in the carriage 208. The carriage 208 is fixed in rotation relative to the device body 206, so that when the shaft 308 is rotated with the threaded aperture 222 engaging the driving section 232, the carriage 208 is moved longitudinally along the device body 206. In some embodiments, a biasing element 313 is provided adjacent one or both of the disengagement sections 236 for biasing the carriage 208 towards the driving section 232 when the threaded aperture 222 is in register with the disengagement section 236.

Movements of the carriage 208 along the shaft 308 is illustrated in FIGS. 9 and 10. In FIG. 9, the carriage 208 is positioned with the threaded aperture 22 in register with the disengagement section 236. In this position, the threads of the shaft 308 are disengaged from the threaded aperture 222, so that the shaft 308 can rotate without causing movements of the carriage 208 along the device body 206 when the shaft 308 is rotated in a direction that would cause the carriage 208 to move away from the driving section 232. In this position, the biasing element 313 is slightly compressed and biases the carriage 208 towards the driving section 232. This facilitates engagement of the threaded aperture 222 with the driving section 232 when the direction of rotation of the shaft 308 is reversed. In FIG. 10, the carriage 208 is positioned with the threaded aperture 222 in register with the driving section 232. In this position, the threads of the shaft 308 are engaged with the threaded aperture 222, so that the shaft 308 can rotate without causing movements of the carriage 208 along the device body 206 when the shaft 308 is rotated.

Another difference between the rod pulling devices 100 and 200 resides in the omission of the rollers 12. Instead, the carriage 208 has a configuration that closely matches the cross-section of the track 213.

Although the present invention has been described hereinabove by way of exemplary embodiments thereof, it will be readily appreciated that many modifications are possible in the exemplary embodiments without materially departing from the novel teachings and advantages of this invention. Accordingly, the scope of the claims should not be limited by the exemplary embodiments, but should be given the broadest interpretation consistent with the description as a whole. The present invention can thus be modified without departing from the spirit and nature of the subject invention as defined in the appended claims.

What is claimed is:

1. A rod pulling device for pulling a rod anchored in surrounding material, the rod pulling device comprising:
a substantially elongated device body;
a carriage movable along the device body;
an actuator operatively coupled to the carriage for selectively moving the carriage along the device body; and
a gripping assembly mounted to the carriage for selectively gripping the rod;
the gripping assembly including a pair of jaws each defining a respective gripping surface for gripping the rod, the gripping surfaces facing each other and defining a gap therebetween for receiving the rod, the jaws being movable between open and closed configurations, wherein the gap is narrower in the closed configuration than in the open configuration;
the rod pulling device further comprising a clutch operative for decoupling the carriage from the actuator so that the carriage is prevented from moving further than a predetermined location along the device body while the actuator remains activated.

2. The rod pulling device as defined in claim 1, wherein the device body defines opposed body proximal and distal ends, the clutch being provided at the body proximal end.

3. The rod pulling device as defined in claim 1, wherein the device body defines opposed body proximal and distal ends, the clutch being provided at the body distal end.

4. The rod pulling device as defined in claim 1, wherein the device body defines opposed body proximal and distal ends, the clutch being a distal clutch and provided at the body distal end, the rod pulling device further comprising a proximal clutch provided at the body proximal end operative for decoupling the carriage from the actuator so that the carriage is prevented from moving further than an other predetermined location along the device body while the actuator remains activated.

5. The rod pulling device as defined in claim 1, wherein
the carriage includes a carriage body mounted to the device body so as to be longitudinally movable therealong while being prevented from rotating thereabout, the carriage body defining a threaded aperture extending longitudinally therethrough;
the actuator includes a shaft extending longitudinally along the device body, the shaft being fixed in translation and axially rotatable relative to the device body, the shaft including a threaded driving section for engaging the threaded aperture;
wherein rotating the shaft relative to the device body with the threaded aperture engaged in the driving section moves the carriage along the device body.

6. The rod pulling device as defined in claim 5, wherein the carriage body is received in a track defined by the device body.

7. The rod pulling device as defined in claim 6, wherein the carriage includes rollers mounted to the carriage body and rotatable relative thereto, the rollers being positioned for engaging the device body at least intermittently when the carriage is moved along the track so as to roll therealong.

8. The rod pulling device as defined in claim 5, wherein
the clutch includes a disengagement section defined by the shaft adjacent the driving section, the carriage body being movable along the shaft so that the disengagement section is reachable by the threaded aperture;
wherein the disengagement section is configured to be disengaged from the threaded aperture when the threaded aperture is in register therewith so that the carriage remains fixed relative to the device body when the threaded aperture reaches the threaded aperture when the shaft is rotated.

9. The rod pulling device as defined in claim 8, wherein the disengagement section is recessed radially relative to the driving section.

10. The rod pulling device as defined in claim 8, further comprising a biasing element provided adjacent the disengagement section and biasing the carriage towards the driving section when the threaded aperture is in register with the disengagement section.

11. The rod pulling device as defined in claim 1, wherein the device body defines a foot for abutting against the surrounding material when the rod is pulled by the gripping assembly; and

12. The rod pulling device as defined in claim 1, wherein:
the carriage includes a carriage body mounted to the device body so as to be longitudinally movable therealong;
the jaws each define opposed jaw first and second ends, the gripping surface being provided at the jaw first end;
the gripping assembly further includes
a link extending between the jaws, the jaws being each pivotally mounted to the link through a respective jaw-to-link pivot adjacent the jaw first ends;
a pair of arms pivotally mounted to the carriage body, the jaws being pivotally mounted to a respective one of the arms closer to the jaw second end than the jaw-to-link pivot, the jaws being mounted to the arms opposed to the carriage body;
wherein a distance between the gripping surface and the link-to-jaw pivot varies along the gripping surface so that moving the link longitudinally relative to the carriage body rotates the jaws relative to the link about the link-to-jaw pivots to result in variations of a width of the gap.

13. The rod pulling device as defined in claim 12, wherein the arms are pivotally mounted to the body so as to be pivotable about respective arm pivot axes laterally spaced apart from each other.

14. The rod pulling device as defined in claim 13, wherein the link and the arms are coplanar, the link being movable to a link proximalmost position relative to the arm pivot axes in which the link and the arms abut against each other, thereby preventing further movements of the link towards the arm pivot axes.

15. The rod pulling device as defined in claim 14, wherein the jaws are in the open position when the link is in the link proximal most position.

16. The rod pulling device as defined in claim 12, wherein the link provides at least two jaw mount pairs each usable for mounting the jaws thereto, the at least two jaw mount pairs each including two jaw mounts, the two jaw mounts being distanced by a jaw mount distance, the jaw mount distances being different for the at least two jaw mount pairs.

17. The rod pulling device as defined in claim 12, wherein the gripping surface includes an arcuate section eccentric relative to the link-to-jaw pivot and a rectilinear section extending from the arcuate section, the gripping surface getting further away from the link pivot along the rectilinear section in a direction leading away from the arcuate section.

18. The rod pulling device as defined in claim 1, wherein the actuator includes a power coupler for coupling the shaft to a power source so that the power source is usable to rotate the shaft.

19. The rod pulling device as defined in claim 18, wherein the power source is a drill, the power coupler including a socket for receiving a socket adapter mounted to the drill.

20. The rod pulling device as defined in claim 1, wherein the gripping surfaces are serrated.
